(19) United States
(12) Patent Application Publication
(10) Pub. No.: US 2022/0118791 A1
(43) Pub. Date: Apr. 21, 2022

(54) IMAGE RECORDING SHEET, IMAGE-DECORATED BODY, AND IMAGE-DECORATED BODY MANUFACTURING METHOD

(71) Applicant: CROSSMINDS CO., LTD., Tokyo (JP)

(72) Inventor: Katsuhiko NISHIMURA, Tokyo (JP)

(21) Appl. No.: 17/296,861

(22) PCT Filed: Nov. 29, 2019
(86) PCT No.: PCT/JP2019/046742

§ 371 Date: Nov. 17, 2021

(30) Foreign Application Priority Data
Nov. 30, 2018 (JP) 2018-224840

(51) Int. Cl. B44C 1/17; G03G 7/00; B32B 27/40; B32B 27/10; B32B 13/12; B32B 17/10

(52) U.S. Cl. CPC B44C 1/172; G03G 7/0073; B32B 27/40; B32B 27/10; B32B 13/12; B32B 2451/00; B32B 2274/00; B32B 2307/732; B32B 2307/51; B32B 2255/10; B32B 2255/12; B32B 17/10

(57) ABSTRACT

An image-decorated sheet including: an image recording sheet; and an image layer formed on an image receiving surface of the image recording sheet with toner using an image forming apparatus, in which the image layer is transferred to a body to be decorated to decorate the body to be decorated, an image-decorated body on which an image is formed by the image-decorated sheet, and an image-decorated body manufacturing method.

### TECHNICAL FIELD

The present invention relates to an image-decorated sheet for forming a toner image on various materials (bodies to be decorated). The present invention also relates to an image-decorated body to which an image is transferred by the image-decorated sheet. The present invention further relates to an image-decorated body manufacturing method.

### BACKGROUND ART

In recent years, full-color images of desired designs have been formed on demand on various materials (bodies to be decorated) including paper, film, and glass. Such image formation depends on properties such as thickness, flexibility, and texture of the material.

In a case where the image is formed using an image forming apparatus, when the thickness of the body to be decorated is uneven and a surface thereof has irregularities, or when the body to be decorated has unique flexibility or a unique texture, it is not easy to form a desired full-color image.

Printing is directly performed on the body to be decorated using a UV inkjet type image forming apparatus. However, due to the principle of the UV inkjet, a degassing device is indispensable because of pungent odor of monomer residues, and it is necessary to leave it for about one day to remove the pungent odor remaining on printed matter to which the image has been transferred. In addition, since a UV curable ink is hard and brittle, it lacks followability to a flexible body to be decorated.

Water transfer is mainly used when full-color on-demand printing is performed on tiles, ceramics, glass, and enamel. In the water transfer, the image is formed on a water transfer sheet (for example, Japanese Patent Application Laid-Open No. H11-78389) by a thermal transfer method, the transfer sheet and an object to be printed are placed in a water tank, the object to be printed is covered with the water transfer sheet, and drying or calcination is performed, and thus the process is complicated. Furthermore, in the case of the water transfer using a dye, since it is difficult to express a desired image, and light resistance is poor, post-processing such as lamination or top coating is required.

Patent Literature 1 describes an electrophotographic laminate film including at least a substrate and an image receiving layer provided on at least one surface of the substrate, in which the image receiving layer contains at least a urethane-modified polyester resin. In this patent literature, an inverted fixed image is formed on the electrophotographic laminate film by an electrophotographic method, and then a surface of the inverted fixed image is thermocompression-bonded in contact with an upper surface of a transfer body to obtain a normal image.

In addition, Patent Literature 2 describes a method for obtaining the normal image by obtaining excellent conveying properties in a fixing step at the time of image formation of an apparatus, and good adhesiveness in a subsequent thermocompression bonding step, when the inverted fixed image is formed on an image recording sheet by the electrophotographic method.

### CITATION LIST

### Patent Literature

Patent Literature 1: Japanese Patent No. 4168846

Patent Literature 2: Japanese Patent Application Laid-Open No. 2017-62419

### SUMMARY OF INVENTION

### Technical Problem

An object of the present invention is to provide an image-decorated sheet for clearly forming a desired electrophotographic image on a body to be decorated having irregularities on a surface thereof, following the irregularities on the surface of the body to be decorated. Another object of the present invention is to provide an image-decorated sheet for clearly forming a desired electrophotographic image on various bodies to be decorated made of a material having flexibility or a material having rigidity, following the body to be decorated.

Still another object of the present invention is to provide an image-decorated body in which a desired electrophotographic image is formed on a body to be decorated having irregularities on a surface thereof, or on various bodies to be decorated made of a material having flexibility or a material having rigidity.

Another object of the present invention is to provide a method for manufacturing an image-decorated body in which a clear image following surface irregularities is formed on a body to be decorated having irregularities on a surface thereof. Still another object of the present invention is to provide a method for manufacturing an image-decorated body in which a clear image following a body to be decorated is formed on various bodies to be decorated made of a material having flexibility or a material having rigidity.

### Solution to Problem

That is, the present invention is as follows.

[1] An image-decorated sheet including: an image recording sheet; and an image layer formed on an image receiving surface of the image recording sheet with toner using an image forming apparatus, wherein the image layer is transferred to a body to be decorated to decorate the body to be decorated.

[2] The image-decorated sheet according to [1], wherein the image recording sheet includes a thermoplastic elastic film.

[3] The image-decorated sheet according to [2], wherein the thermoplastic elastic film has a thickness of 10 μm to 35 μm and a stretchability of 500 to 800%.

[4] The image-decorated sheet according to [2] or [3], wherein the thermoplastic elastic film is a non-yellowing polyurethane hot melt film having a flow starting temperature of 110° C. when a film thickness is 50 μm, and a uniaxial elongation viscosity of 8×10² Pa·s and 5×10² Pa·s respectively at 120° C. and 130° C.

[5] The image-decorated sheet according to any one of [2] to [4], wherein the image recording sheet includes a thermoplastic elastic film and a release liner.

[6] The image-decorated sheet according to [1], wherein the image recording sheet is a base material having, on at least one surface thereof, a cover layer capable of holding the image layer formed of toner and being removable after the image layer is transferred to the body to be decorated.

[7] The image-decorated sheet according to [6], wherein the base material having the cover layer is release paper having a silicone treatment layer.

[8] The image-decorated sheet according to [7], wherein the release paper is laminated in an order of the silicone treatment layer, a clay coating layer, and paper.

[9] The image-decorated sheet according to [6], wherein breaking elongation of the cover layer is 50% or less, and a water-soluble layer is further included between the cover layer and the base material.

[10] The image-decorated sheet according to any one of [6] to [9], wherein the base material is removed after the image layer is transferred to the body to be decorated.

[11] The image-decorated sheet according to [1], wherein the image recording sheet is an aqueous polyurethane film capable of holding the image layer formed of toner on at least one surface thereof.

[12] The image-decorated sheet according to [11], wherein the aqueous polyurethane film is removed after the image layer is transferred to the body to be decorated.

[13] An image-decorated body having an image layer formed of a developer image made of toner on a surface of a body to be decorated.

[14] The image-decorated body according to [13], wherein an image recording sheet includes a thermoplastic elastic film.

[15] The image-decorated body according to [14], wherein the image recording sheet includes the thermoplastic elastic film having a thickness of 10 μm to 35 μm and a stretchability of 500 to 800%.

[16] The image-decorated body according to [14] or [15], wherein the thermoplastic elastic film is a non-yellowing polyurethane hot melt film having a flow starting temperature of 110° C. when a film thickness is 50 μm, and a uniaxial elongation viscosity of 8×10² Pa·s and 5×10² Pa·s respectively at 120° C. and 130° C.

[17] The image-decorated body according to any one of [14] to [16], wherein the image layer is a part of an image-decorated sheet in which the image layer and the image recording sheet are integrated.

[18] The image-decorated body according to [13], wherein the image layer is a layer transferred by the image-decorated sheet according to any one of [6] to [12].

[19] The image-decorated body according to [18], further including a protective layer on a surface of the image layer opposite to the body to be decorated.

[20] The image-decorated body according to any one of [13] to [19], wherein the body to be decorated is one or more selected from paper, Japanese paper, Western paper, silk canvas, gold foil paper, pseudo gold foil paper, brass foil paper, whitewash paper, lacquer, tile, ceramic, glass, metal, stainless steel, plastic, film, wood, diatomaceous earth plate, and enamel.

[21] The image-decorated sheet according to any one of [1] to [12] or the image-decorated body according to any one of [13] to [20], wherein the toner is oilless toner or toner produced by an emulsion polymerization method.

[22] A manufacturing method for manufacturing the image-decorated body according to any one of [13] to [21], including the following steps.

Step 1) forming an image layer of toner on an image receiving surface of an image recording sheet using an image forming apparatus to obtain an image-decorated sheet

Step 2) placing a body to be decorated on a surface on the image layer side of the image-decorated sheet obtained in the step 1 to obtain a laminate, and then heating and pressurizing the obtained laminate

[23] The manufacturing method according to [22], further including a step of providing a conveyance base material layer on at least the image-decorated sheet side of the laminate before heating and pressurizing in the step 2, and peeling off the conveyance base material layer after heating and pressurizing.

[24] The manufacturing method according to [22] or [23], wherein the image recording sheet is a thermoplastic elastic film, and the manufacturing method includes: a pre-treatment step of applying a plastic film liner to a surface of the thermoplastic elastic film on a side opposite to an image receiving layer before the step 1; and a post-treatment step of peeling off the plastic film liner after the step 2.

[25] The manufacturing method according to [22] or [23], wherein the image recording sheet is a base material having, on at least one surface thereof, a cover layer capable of holding the image layer formed of toner and being removable after the image layer is transferred to the body to be decorated.

[26] The manufacturing method according to [25], wherein the base material having the cover layer is release paper having a silicone treatment layer.

[27] The manufacturing method according to [26], wherein the release paper is laminated in an order of the silicone treatment layer, a clay coating layer, and paper.

[28] The manufacturing method according to [22] or [23], wherein breaking elongation of the cover layer is 50% or less, and a water-soluble layer is further included between the cover layer and the base material.

[29] The manufacturing method according to [28], including a step of removing the base material by washing with water after the step 2.

[30] The manufacturing method according to [29], further including a step of removing the cover layer after removing the base material by washing with water.

[31] The manufacturing method according to [22] or [23], wherein the image recording sheet is an aqueous polyurethane film capable of holding the image layer formed of toner on at least one surface thereof.

[32] The manufacturing method according to [31], including a step of removing the aqueous polyurethane film after the step 2.

### Advantageous Effects of Invention

According to the present invention, it is possible to form a desired design by a toner image on various bodies to be decorated, for example, paper, Japanese paper, Western paper, silk canvas, gold foil paper, pseudo gold foil paper, brass foil paper, whitewash paper, lacquer, tile, ceramic, glass, metal, stainless steel, plastic, film, wood, diatomaceous earth plate, enamel, and the like, for which it has been difficult to form a desired design on demand. According to the present invention, it is also possible to provide an image-decorated body to which the desired design by the toner image is applied.

### BRIEF DESCRIPTION OF DRAWINGS

FIG. 1 is a cross-sectional view illustrating one aspect of an image-decorated sheet of the present invention.

FIG. 2 is a graph illustrating a relationship between temperature and viscosity of an image recording sheet in one aspect of the present invention. TPU represents a general thermoplastic elastic polyurethane film, and UNH represents a non-yellowing polyurethane hot melt film UNIMELT UNH790 (manufactured by NIHON UNIPOLYMER CO. LTD).

FIG. 3 is a cross-sectional view illustrating one aspect of an image-decorated body of the present invention.

FIG. 4 is a cross-sectional view illustrating one aspect of a laminate of the present invention.

FIG. 5 is a schematic view of a pressure heating apparatus usable in the aspect of the present invention.

FIG. 6 is a photograph of the image-decorated body (shot glass) obtained in Production Example 10.

FIG. 7 is a photograph of the image-decorated body (glass plate) obtained in Production Example 11.

FIG. 8 shows the image-decorated body obtained in Production Example 15 on the left side of the photograph, and shows the image-decorated body obtained in Production Example 16 on the right side of the photograph. In Production Example 16, since gloss adjustment was performed with a release liner, gloss on the right side in the photograph is higher than that on the left side.

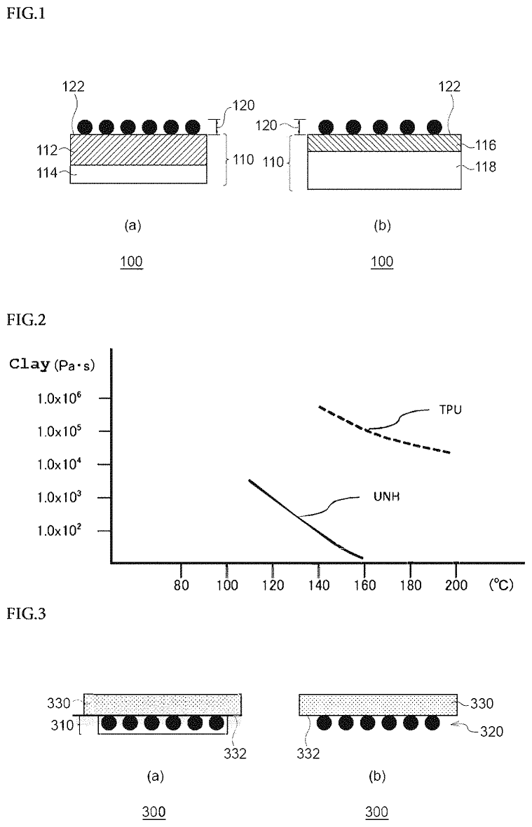

### DESCRIPTION OF EMBODIMENTS

Hereinafter, the present invention will be described in detail.

### Image-Decorated Sheet

An image-decorated sheet of the present invention includes an image recording sheet having an image receiving surface on at least one surface thereof, and an image layer formed of toner using an image forming apparatus. The image-decorated sheet is a sheet for decorating a body to be decorated by transferring an image layer formed on the image receiving surface of the image recording sheet to the body to be decorated.

### Image Recording Sheet

In one aspect, the image recording sheet includes a thermoplastic elastic film. Examples of the thermoplastic elastic film include a polyurethane film. A thickness of the thermoplastic elastic film can be appropriately selected according to the body to be decorated and manufacturing conditions, and is not particularly limited, but can be, for example, 10 μm to 35 μm. Further, the thermoplastic elastic film preferably has a stretchability of 500 to 800% from a viewpoint of decorating the body to be decorated by thermocompression bonding. Furthermore, the thermoplastic elastic film is preferably a non-yellowing polyurethane hot melt film having a flow starting temperature of 110° C. when a film thickness is 50 μm, and a uniaxial elongation viscosity of 8×10² Pa·s and 5×10² Pa·s respectively at 120° C. and 130° C., from the viewpoint of decorating the body to be decorated by heating and pressurization.

Further, the thermoplastic elastic film may have a release liner made of paper or a plastic film. Furthermore, the thermoplastic elastic film is preferably transparent in order to more faithfully express color of the image layer made of toner.

As such a thermoplastic elastic film, a known film can be used and is not particularly limited, but preferable examples thereof include a non-yellowing polyurethane hot melt film UNIMELT UNH790 (manufactured by NIHON UNIPOLYMER CO. LTD) and a polyurethane film Tough Grace (manufactured by Takeda Sangyo Corporation).

In the image recording sheet, the thermoplastic elastic film and the release liner may be laminated. Examples of the release liner include a liner made of a plastic film such as polyethylene, or paper. The release liner is released after the image layer is transferred to the body to be decorated. Further, gloss of the image layer formed on an image-decorated body can be adjusted by using the release liner having a flat film surface as the release liner.

In another aspect, the image recording sheet can be a base material having, on at least one surface thereof, a cover layer capable of holding the image layer formed of toner and being removable after the image layer is transferred to the body to be decorated.

In this case, in one aspect, release paper having a silicone treatment layer can be used as the base material having the cover layer. The release paper may be laminated in an order of the silicone treatment layer, a clay coating layer, and paper. In this aspect, a surface of the silicone treatment layer serves as the image receiving surface of the image recording sheet. As such release paper, known release paper can be used and is not particularly limited, but examples of preferable release paper include release paper EV130R and ESR180NC-3A (manufactured by LINTEC Corporation). The release paper is peeled off after the image layer is transferred to the body to be decorated.

In still another aspect, the base material having the cover layer having a breaking elongation of 50% or less can be used, and a water-soluble layer may be further included between the cover layer and the base material. In this case, the base material can be removed by dissolving the water-soluble layer by washing with water after the image layer is transferred to the body to be decorated. Examples of such a base material include a sheet in which the cover layer having the image receiving surface capable of holding the image layer formed of toner, the water-soluble layer, and a base material layer are laminated in this order, that is, A-one transfer tattoo seal-on white 52207 manufactured by 3M Japan Limited, or a water transfer sheet described in Japanese Patent Application Laid-Open No. H11-78389.

In one aspect, the image recording sheet can be an aqueous polyurethane film capable of holding the image layer formed of toner on at least one surface thereof. The aqueous polyurethane film is preferably thermosetting, and examples of such an aqueous polyurethane film include Condom Zero One manufactured by Okamoto Industries, Inc. The aqueous polyurethane film is removed after the image layer is transferred to the body to be decorated.

A thickness of the image recording sheet is not particularly limited as long as it can form the image layer by the image forming apparatus. For example, the thickness can be 50 μm to 300 μm, and preferably 70 μm to 200 μm.

### Image Layer

The image layer includes a developer image formed on the image receiving surface of the image recording sheet with toner using the image forming apparatus.

Here, the image forming apparatus may be a toner type apparatus, and is not particularly limited. For example, DocuColor series, which is a high quality laser printer manufactured by Fuji Xerox Co., Ltd., can be used. In addition, known toner can be used as the toner and is not particularly limited, but it is preferable to use oilless toner, EA toner or EA-Eco toner (manufactured by Fuji Xerox Co., Ltd.) manufactured by an emulsion polymerization method in order to accurately transfer a desired image. Among them, it is more preferable to use the EA-Eco toner having a fixing temperature lower than that of the EA toner.

The image-decorated sheet of the present invention can be manufactured, for example, as follows. In a case where the thermoplastic elastic film is used as the image recording sheet, the thermoplastic elastic film is loaded in the laser printer in such a direction that a toner image is formed on the image receiving surface, and the image layer is formed by mirror image data of the desired image transmitted in advance to a control unit of the laser printer, so that the image-decorated sheet can be obtained.

Further, in a case where the base material having the cover layer or the aqueous polyurethane film is used as the image recording sheet, the release paper is loaded in the laser printer in such a direction that the toner image is formed on a surface of the cover layer such as the silicone treatment layer, or the film surface, which is the image receiving surface, and the image layer is formed by the mirror image data of the desired image transmitted in advance to the control unit of the laser printer, so that the image-decorated sheet can be obtained.

### Image-Decorated Body

The image-decorated body of the present invention has the image layer including the developer image made of toner on a surface of the body to be decorated. Further, a transfer assist layer may be provided between the surface of the body to be decorated and the image layer.

In one aspect, the image layer of the image-decorated body may be a part of the image-decorated sheet in which the image layer and the image recording sheet are integrated. In this aspect, the image-decorated sheet can be a sheet in which the image layer made of toner is formed on the image receiving surface of an image forming sheet including the thermoplastic elastic film. For example, as illustrated in FIG. 1(a), the body to be decorated is placed on a surface on an image layer side of the image-decorated sheet, in which the image layer is formed on the thermoplastic elastic film having the release liner, and the image-decorated body is manufactured by heating and pressurizing the thermoplastic elastic film to a temperature at which it melts, so that the image-decorated sheet in which the image layer and the image recording sheet are integrated can be held on the surface of the body to be decorated, as illustrated in FIG. 3(a).

In another aspect, the image layer of the image-decorated body includes only the image layer made of toner. In order to manufacture the image-decorated body of this aspect, the image-decorated sheet can be a sheet in which the image layer made of toner is formed on the image receiving surface of the image recording sheet including the base material having the cover layer or the image recording sheet made of the aqueous polyurethane film. The body to be decorated is placed on the surface on the image layer side of the image-decorated sheet, to be heated and pressurized, and then only the image recording sheet is peeled off, so that the image layer is held on the surface of the body to be decorated, as illustrated in FIG. 3(b).

The body to be decorated used for the image-decorated body is not limited as long as it is made of a material that can withstand heating and pressurization in a manufacturing process. A material having flexibility, a material having rigidity, and the like can be widely used. Examples of such a body to be decorated include paper, Japanese paper, Western paper, silk canvas, gold foil paper, pseudo gold foil paper, brass foil paper, whitewash paper, lacquer, tile, ceramic, glass, metal, stainless steel, plastic, film, wood, diatomaceous earth plate, and enamel.

The transfer assist layer is a layer that can be provided between the body to be decorated and the image layer, and necessity and material of the transfer assist layer can be selected depending on the type and surface characteristics of the body to be decorated and the application of the image-decorated body. As the transfer assist layer, for example, a rough surface film, glue, spray glue, or the like can be used.

In the image-decorated body of the present invention, a protective layer can be further provided on an outside of the image layer, that is, on a surface of the image layer opposite to the body to be decorated. The protective layer can be used to protect the image layer or adjust texture or color of the image, and the material can be selected according to the application or purpose. As such a protective layer, for example, a known coating agent (one that does not dissolve toner), a UV curable resin, a film, or the like can be used.

The image-decorated body of the present invention can be manufactured by the following manufacturing method of the image-decorated body.

### Image-Decorated Body Manufacturing Method

An image-decorated body manufacturing method of the present invention will be described. The image-decorated body manufacturing method of the present invention includes the following steps.

Step 1) forming an image layer of toner on an image receiving surface of an image recording sheet using an image forming apparatus to obtain an image-decorated sheet

Step 2) placing a body to be decorated on a surface on the image layer side of the image-decorated sheet obtained in the step 1 to obtain a laminate, and then heating and pressurizing the obtained laminate

A step of obtaining the image-decorated sheet in Step 1 is as described above.

In Step 2, first, the body to be decorated is directly or indirectly placed on a surface of the image-decorated sheet on the image layer side to obtain the laminate. In the case of indirect placement, Step 1 may be followed by a step of providing the transfer assist layer on the image layer side of the image-decorated sheet, that is, between the image-decorated sheet and the body to be decorated.

Subsequently, the laminate is heated and pressurized. Heating and pressurization can be performed using, for example, a pressure heating apparatus illustrated in FIG. 5. In FIG. 5, the heating and pressurization can be performed by loading a laminate M in the device so as to move between rollers in an E direction.

Heating condition and pressurizing condition can be appropriately selected depending on the image recording sheet and the body to be decorated. Heating temperature can be, for example, 80° C. to 200° C., preferably 120° C. to 140° C., and heating time can be, for example, about several seconds to several minutes. The pressurization condition can be, for example, 0.5 kg to 10 kg. When the thermoplastic elastic film is used as the image recording sheet and is integrated with the image layer to be formed into the body to be decorated, it is necessary to heat the film at a temperature at which the film to be used melts for a certain period of time.

When the body to be decorated has a shape or a material that cannot be applied to the pressure heating apparatus of FIG. 5, the heating can be performed using a known clothes iron, steamer, dryer, heat gun, or the like, and the pressurization is preferably performed by covering and pressing the surface with a releasable material following an aspect of the body to be decorated because the image layer and the body to be decorated are not damaged.

The manufacturing method may further include a step of providing a conveyance base material layer at least on the image-decorated sheet side of the laminate before heating and pressurization, and peeling off the conveyance base material layer after heating and pressurization. By providing the conveyance base material layer, strength of the laminate can be secured, the image-decorated sheet and the body to be decorated can be protected during heating and pressurization, and the desired image can be clearly formed on the body to be decorated.

The necessity and material of the conveyance base material layer can be selected depending on the image recording sheet to be used and the manufacturing conditions, and the conveyance base material layer is not particularly limited. As the conveyance base material layer, a conventionally known plastic film or paper having releasability, specifically, for example, Releasy produced by KIMOTO Co., Ltd. can be used.

### EXAMPLES

Although the present invention is described below with reference to specific embodiments, it is understood that the present invention is not limited to the embodiments, and various changes and modifications therein may be made by those skilled in the art without departing from the scope or spirit of the present invention as defined in the appended claims.

### Production of Image-Decorated Sheet

### Production Example 1

As image recording sheets, non-yellowing polyurethane hot melt film UNIMELT UNH790 (manufactured by NIHON UNIPOLYMER CO. LTD) having a release liner and thicknesses of 20 μm, 25 μm, and 30 μm were prepared. The image recording sheets were set in an image recording apparatus (DocuColor1450GA manufactured by Fuji Xerox Co., Ltd.) such that the toner images were formed on the image receiving surfaces of the image recording sheets, and a desired electrophotographic image was transmitted to the image recording apparatus to form image layers, so that image-decorated sheets were obtained. As the toner, a toner manufactured by the emulsion polymerization method (EA-Eco toner manufactured by Fuji Xerox Co., Ltd.) was used.

### Production Example 1-2

The release liner was removed from the non-yellowing polyurethane hot melt film UNIMELT UNH790 (manufactured by NIHON UNIPOLYMER CO. LTD) of Production Example 1, and a new release liner (KOKUYO color laser inkjet label, HATTE-HAGASERU (stick and peel off) KPC-HH101-20) was attached thereto to prepare the image recording sheet. Subsequently, the image-decorated sheet was obtained in the same manner as in Production Example 1.

### Production Example 2

The image-decorated sheet was obtained in the same manner as in Production Example 1 except that the polyurethane film Tough Grace (manufactured by Takeda Sangyo Corporation) having the release liner and a thickness of 35 μm was used as the image recording sheet.

### Production Example 3

As the image recording sheet, a sheet in which the cover layer having the image receiving surface capable of holding the image layer formed of toner, the water-soluble layer, and the base material layer were laminated in this order (A-one transfer tattoo seal-on white 52207 manufactured by 3M Japan Limited) was prepared. The sheet was set in the image recording apparatus (DocuColor1450GA manufactured by Fuji Xerox Co., Ltd.) such that the toner image was formed on the image receiving surface of the sheet, and the desired electrophotographic image was transmitted to the image recording apparatus to form the image layer, so that the image-decorated sheet was obtained. As the toner, a toner manufactured by the emulsion polymerization method (EA-Eco toner manufactured by Fuji Xerox Co., Ltd.) was used.

### Production Example 4

The image-decorated sheet was obtained in the same manner as in Production Example 3 except that the release paper (EV130R manufactured by LINTEC Corporation) in which the silicone treatment layer, the clay coating layer, and paper were laminated in this order was used as the image recording sheet.

### Production Example 5

As the image recording sheet, the aqueous polyurethane film (Condom Zero One manufactured by OKAMOTO INDUSTRIES, INC.) having the image receiving surface capable of holding the image layer formed of toner was washed in advance with tap water, spread on a PET film, and dried, and an excessive oil content was removed with 100% water purification skin permeation electrolyzed water having an emulsifying action manufactured by Cross Mines Co., Ltd. Subsequently, the prepared aqueous polyurethane film was spread on the conveyance base material layer (KOKUYO color laser inkjet label, HATTE-HAGASERU (stick and peel off) label paper 30 KPC-HH101-20). The sheet was set in the image recording apparatus (DocuColor1450GA manufactured by Fuji Xerox Co., Ltd.) such that the toner image was formed on the image receiving surface of the sheet, and the desired electrophotographic image was transmitted to the image recording apparatus to form the image layer, so that the image-decorated sheet was obtained. As the toner, a toner manufactured by the emulsion polymerization method (EA-Eco toner manufactured by Fuji Xerox Co., Ltd.) was used.

### Production of Image-Decorated Body

### Production Example 6

The laminate was obtained by laminating new TORINOKO paper (a type of Japanese paper) as the body to be decorated on the surface on the image layer side of the image-decorated sheet obtained in Production Example 1. Subsequently, the laminate was loaded in the pressure heating apparatus (Lami Packer LPD3226Meister6 manufactured by Fuji Plastics Co., Ltd.) and passed between heated rollers to be thermocompression-bonded. The heating temperature was set to 120° C. to 160° C. The release liner was removed from the laminate taken out from the pressure heating apparatus to obtain the image-decorated body in which the desired image was formed on the new TORINOKO paper. The obtained image was a faithfully reproduced image of the electrophotographic image transmitted to the image recording apparatus, and the image recording sheet was melted to be integrated with the toner image, and was welded following surface irregularities of the new TORINOKO paper.

### Production Example 7

The new TORINOKO paper (a type of Japanese paper) as the body to be decorated was laminated on the surface on the image layer side of the image-decorated sheet obtained in Production Example 2 to obtain the laminate. Subsequently, the laminate was loaded in the pressure heating apparatus (Lami Packer LPD3226Meister6 manufactured by Fuji Plastics Co., Ltd.) and passed between heated rollers to be thermocompression-bonded. The heating temperature was set to 120° C. to 160° C. The release liner was removed from the laminate taken out from the pressure heating apparatus to obtain the image-decorated body in which the desired image was formed on the new TORINOKO paper. The obtained image was a faithfully reproduced image of the electrophotographic image transmitted to the image recording apparatus, and the image recording sheet was melted to be integrated with the toner image, and was welded following surface irregularities of the new TORINOKO paper.

### Production Example 8

The new TORINOKO paper (a type of Japanese paper) was laminated as the body to be decorated on the surface on the image layer side of the image-decorated sheet obtained in Production Example 4 to obtain the laminate. Subsequently, the laminate was loaded in the pressure heating apparatus (Lami Packer LPD3226Meister6 manufactured by Fuji Plastics Co., Ltd.) and passed between heated rollers to be thermocompression-bonded. The heating temperature was set to 120° C. to 160° C. The release paper (EV130R manufactured by Corporation) was removed from the laminate taken out from the pressure heating apparatus to obtain the image-decorated body in which the desired image was formed by the image layer made of only toner on the new TORINOKO paper. The obtained image was a faithfully reproduced image of the electrophotographic image transmitted to the image recording apparatus, and followed the surface irregularities of the new TORINOKO paper.

### Production Example 9

The image-decorated body was obtained in the same manner as in Production Example 8 except that the pseudo gold foil paper (obtained as a sample from Kataoka Folding Screen Store Co., Ltd.) was used as the body to be decorated. The obtained image was a faithfully reproduced image of the electrophotographic image transmitted to the image recording apparatus, and followed the pseudo gold foil paper. No wrinkles or cracks were found in the pseudo gold foil paper.

### Production Example 10

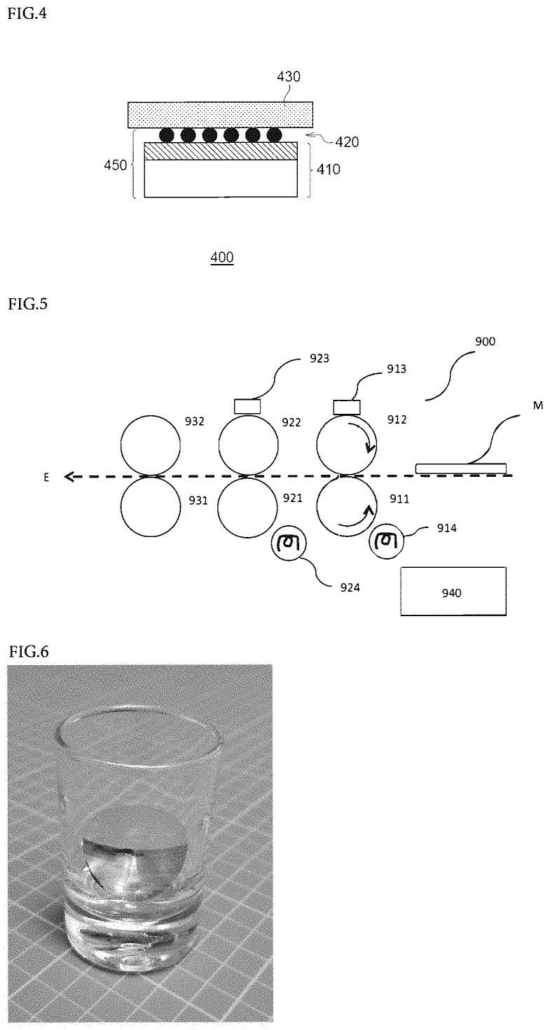

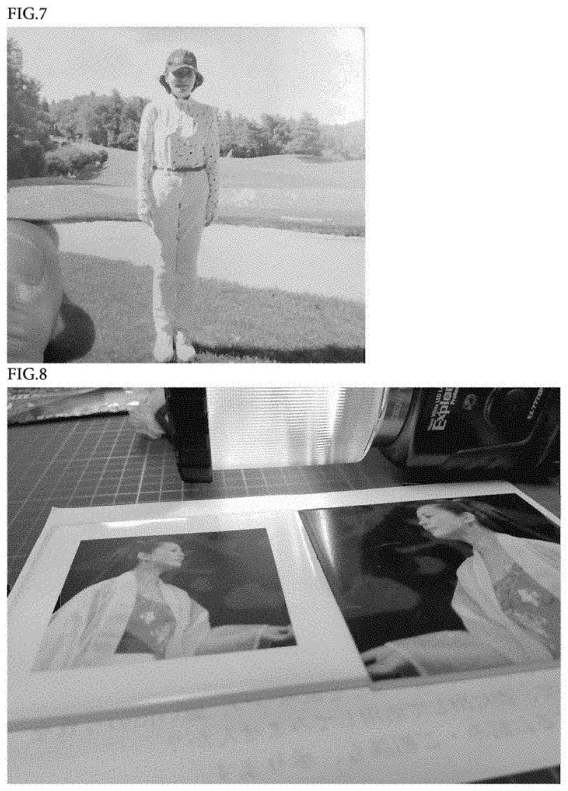

The surface on the image layer side of the image-decorated sheet obtained in Production Example 3 was superimposed to follow a surface of the shot glass which is the body to be decorated. Subsequently, the image-decorated sheet was covered with the releasable material following the aspect from above, and the image-decorated sheet was thermocompression-bonded with a small clothes iron (garment steamer high power steam Veholion TIMI-2) at a heating temperature of 120° C. to 160° C. Thereafter, the releasable material was removed, and the base material was removed by washing with water. Further, the cover layer was removed by rubbing with hot water to obtain the image-decorated body (FIG. 6) in which the desired image was formed on the surface (curved surface) of the shot glass. The obtained image was a faithfully reproduced image of the electrophotographic image transmitted to the image recording apparatus, and was firmly held on the surface of the shot glass.

### Production Example 11

The surface on the image layer side of the image-decorated sheet obtained in Production Example 3 was superimposed on a glass plate which is the body to be decorated. This laminate was loaded in the pressure heating apparatus (Lami Packer LPD3226Meister6 manufactured by Fuji Plastics Co., Ltd.) and passed between the heated rollers to be thermocompression-bonded. The heating temperature was set to 120° C. to 160° C. Subsequently, the releasable material was removed, and the base material was removed by washing with water. Further, the cover layer was removed by rubbing with hot water to obtain the image-decorated body (FIG. 7) in which the desired image was formed on a surface of the glass plate. The obtained image was a faithfully reproduced image of the electrophotographic image transmitted to the image recording apparatus, and was firmly held on the surface of the glass plate.

### Production Example 12

The laminate was obtained by laminating the pseudo gold foil paper (obtained as a sample from Kataoka Folding Screen Store Co., Ltd.) as the body to be decorated on the surface on the image layer side of the image-decorated sheet obtained in Production Example 5. Subsequently, the laminate was loaded in the pressure heating apparatus (Lami Packer LPD3226Meister6 manufactured by Fuji Plastics Co., Ltd.) and passed between heated rollers to be thermocompression-bonded. The heating temperature was set to 120° C. to 160° C. The conveyance base material layer and the aqueous polyurethane film were removed in this order from the laminate taken out from the pressure heating apparatus to obtain the image-decorated body in which the desired image was formed by the image layer including only toner on the pseudo gold foil paper. The obtained image was a faithfully reproduced image of the electrophotographic image transmitted to the image recording apparatus, and followed the pseudo gold foil paper. No wrinkles or cracks were found in the pseudo gold foil paper.

### Production Example 13

The image-decorated body was obtained in the same manner as in Production Example 12 except that the glass plate was used as the body to be decorated. The obtained image was a faithfully reproduced image of the electrophotographic image transmitted to the image recording apparatus, and was firmly held on the surface of the glass plate.

### Production Example 14

The laminate was obtained by laminating a film (a film in which a stretchable milky white elastic film layer having a thickness of 72 μm is laminated on a paint film having a thickness of 142 μm: a paint film PF001C rough surface, concrete, tile, short-term, white, manufactured by 3M Japan Limited) as the body to be decorated on the surface on the image layer side of the image-decorated sheet obtained in Production Example 1. Subsequently, heating and pressurization were performed in the same manner as in Production Example 6 to obtain the image-decorated body. The obtained image (left side in FIG. 8) is a faithfully reproduced image of the electrophotographic image transmitted to the image recording apparatus, and the image recording sheet was melted to be integrated with the toner image, and was welded following the film surface.

### Production Example 15

The laminate was obtained by laminating the film (a film in which a stretchable milky white elastic film layer having a thickness of 72 μm is laminated on a paint film having a thickness of 142 μm: a paint film PF001C rough surface, concrete, tile, short-term, white, manufactured by 3M Japan Limited) as the body to be decorated on the surface on the image layer side of the image-decorated sheet obtained in Production Example 1-2. Subsequently, heating and pressurization were performed in the same manner as in Production Example 6, and the release liner was removed to obtain the image-decorated body. The obtained image (right side in FIG. 8) is a faithfully reproduced image of the electrophotographic image transmitted to the image recording apparatus, and the image recording sheet was melted to be integrated with the toner image, and was welded following the film surface. Furthermore, since the gloss of the surface was adjusted by the release liner having a flat surface, the gloss is higher in the photograph on the right side of FIG. 8 than in the photograph on the left side of FIG. 8.

### Reference Example

The image-decorated sheet and the image-decorated body were manufactured in the same manner as in Production Examples 1 and 6 except that polyvinylidene chloride wrap (Kurewrap (registered trademark) manufactured by KUREHA CORPORATION) having an average thickness of 10 μm was used as the image recording sheet. In the obtained image-decorated body, the image-decorated sheet and the body to be decorated were in close contact with each other in a part of the toner, but were not in close contact with each other in other parts.

### INDUSTRIAL APPLICABILITY

According to the present invention, it is possible to form the toner image on the body to be decorated such as paper, Japanese paper, Western paper, silk canvas, gold foil paper, pseudo gold foil paper, brass foil paper, whitewash paper, lacquer, tile, ceramic, glass, metal, stainless steel, plastic, film, wood, diatomaceous earth plate, and enamel. That is, according to the present invention, it is possible to obtain the image-decorated body in which the toner image is formed on a body to be decorated as if copying is performed on plain paper with toner.

### REFERENCE SIGNS LIST

100, 450 Image-decorated sheet
110, 410 Image recording sheet
112 Thermoplastic elastic film
114 Release liner
116 Clay coating layer
118 Paper
120, 320, 420 Image layer
122 Image receiving surface
300 Image-decorated body
310 Image-decorated sheet in which image layer and image recording sheet are integrated
330, 430 Body to be decorated
400 Laminate
900 Pressure heating apparatus
911, 912, 921, 922, 931, 932 Heating and pressurizing roller
914, 924 Heater
940 Control device
913, 923 Temperature detector

1. An image-decorated sheet comprising:
an image recording sheet; and
an image layer formed on an image receiving surface of the image recording sheet with toner using an image forming apparatus,
wherein the image layer is transferred to a body to be decorated to decorate the body to be decorated.

2. The image-decorated sheet according to claim 1, wherein the image recording sheet includes a thermoplastic elastic film.

3. The image-decorated sheet according to claim 2, wherein the thermoplastic elastic film has a thickness of 10 μm to 35 μm and a stretchability of 500 to 800%.

4. The image-decorated sheet according to claim 2, wherein the thermoplastic elastic film is a non-yellowing polyurethane hot melt film having a flow starting temperature of 110° C. when a film thickness is 50 μm, and a uniaxial elongation viscosity of 8×10² Pa·s and 5×10² Pa·s respectively at 120° C. and 130° C.

5. The image-decorated sheet according to claim 2, wherein the image recording sheet includes a thermoplastic elastic film and a release liner.

6. The image-decorated sheet according to claim 1, wherein the image recording sheet is a base material having, on at least one surface thereof, a cover layer capable of holding the image layer formed of toner and being removable after the image layer is transferred to the body to be decorated.

7. The image-decorated sheet according to claim 6, wherein the base material having the cover layer is release paper having a silicone treatment layer.

8. The image-decorated sheet according to claim 7, wherein the release paper is laminated in an order of the silicone treatment layer, a clay coating layer, and paper.

9. The image-decorated sheet according to claim 6, wherein breaking elongation of the cover layer is 50% or less, and a water-soluble layer is further included between the cover layer and the base material.

10. The image-decorated sheet according to claim 6, wherein the base material is removed after the image layer is transferred to the body to be decorated.

11. The image-decorated sheet according to claim 1, wherein the image recording sheet is an aqueous polyurethane film capable of holding the image layer formed of toner on at least one surface thereof.

12. The image-decorated sheet according to claim 11, wherein the aqueous polyurethane film is removed after the image layer is transferred to the body to be decorated.

13. An image-decorated body having an image layer formed of a developer image made of toner on a surface of a body to be decorated.

14. The image-decorated body according to claim 13, wherein an image recording sheet includes a thermoplastic elastic film.

15. The image-decorated body according to claim 14, wherein the image recording sheet includes the thermoplastic elastic film having a thickness of 10 μm to 35 μm and a stretchability of 500 to 800%.

16. The image-decorated body according to claim 14, wherein the thermoplastic elastic film is a non-yellowing polyurethane hot melt film having a flow starting temperature of 110° C. when a film thickness is 50 μm, and a uniaxial elongation viscosity of 8×10² Pa·s and 5×10² Pa·s respectively at 120° C. and 130° C.

17. The image-decorated body according to claim 14, wherein the image layer is a part of an image-decorated sheet in which the image layer and the image recording sheet are integrated.

18. The image-decorated body according to claim 13, wherein the image layer is a layer transferred by an image-decorated sheet,
wherein the image-decorated sheet comprises:
an image recording sheet; and
an image layer formed on an image receiving surface of the image recording sheet with toner using an image forming apparatus,
wherein the image layer is transferred to a body to be decorated to decorate the body to be decorated, and
wherein the image recording sheet is a base material having, on at least one surface thereof, a cover layer capable of holding the image layer formed of toner and being removable after the image layer is transferred to the body to be decorated.

19. The image-decorated body according to claim 18, further comprising a protective layer on a surface of the image layer opposite to the body to be decorated.

20. The image-decorated body according to claim 13, wherein the body to be decorated is one or more selected from the group consisting of paper, Japanese paper, Western paper, silk canvas, gold foil paper, pseudo gold foil paper, brass foil paper, whitewash paper, lacquer, tile, ceramic, glass, metal, stainless steel, plastic, film, wood, diatomaceous earth plate, and enamel.

21. The image-decorated sheet according claim 1 or an image-decorated body having an image layer formed of a developer image made of toner on a surface of a body to be decorated, wherein the toner is oilless toner or toner produced by an emulsion polymerization method.

22. A manufacturing method for manufacturing the image-decorated body according to claim 13, comprising:
forming the image layer of the toner on an image receiving surface of an image recording sheet using an image forming apparatus so as to obtain an image-decorated sheet; and
placing the body to be decorated on a surface on a side of the image layer of the resulting image-decorated sheet so as to obtain a laminate, and then heating and pressurizing the obtained laminate.

23. The manufacturing method according to claim 22, further comprising:
providing a conveyance base material layer at least on an image-decorated sheet side of the laminate before the heating and pressurizing the laminate; and
peeling off the conveyance base material layer after the heating and pressurizing.

24. The manufacturing method according to claim 23,
wherein the image recording sheet is a thermoplastic elastic film, and
the manufacturing method further comprises:
as a pre-treatment, applying a plastic film liner to a surface of the thermoplastic elastic film on a side opposite to the image receiving surface thereof before the forming the image layer; and
as a post-treatment, peeling off the plastic film liner after the heating and pressuring the laminate.

25. The manufacturing method according to claim 23, wherein the image recording sheet is a base material having, on at least one surface thereof, a cover layer capable of holding the image layer formed of the toner and being removable after the image layer is transferred to the body to be decorated.

26. The manufacturing method according to claim 25, wherein the base material having the cover layer is release paper having a silicone treatment layer.

27. The manufacturing method according to claim 26, wherein the release paper is laminated in an order of the silicone treatment layer, a clay coating layer, and paper.

28. The manufacturing method according to claim 25, wherein breaking elongation of the cover layer is 50% or less, and
a water-soluble layer is further included between the cover layer and the base material.

29. The manufacturing method according to claim 28, the manufacturing method further comprising removing the base material by washing with water after the heating and pressurizing the laminate.

30. The manufacturing method according to claim 29, further comprising removing the cover layer after the removing the base material by washing with water.

31. The manufacturing method according to claim 23, wherein the image recording sheet is an aqueous polyurethane film capable of holding the image layer formed of the toner on at least one surface thereof.

32. The manufacturing method according to claim 31, comprising removing the aqueous polyurethane film after the heating and pressurizing the laminate.
